(19) United States
(12) Patent Application Publication
(10) Pub. No.: US 2026/0159116 A1
(43) Pub. Date: Jun. 11, 2026

(54) REAL TIME PREDICTIVE DRIVING MANEUVER ASSIST FOR AUTONOMOUS DRIVING APPLICATIONS

(71) Applicant: AUTOBRAINS TECHNOLOGIES LTD, Tel Aviv-Yafo (IL)

(72) Inventor: Ido COHEN, Tel Aviv-Yafo (IL)

(73) Assignee: AUTOBRAINS TECHNOLOGIES LTD, Tel Aviv-Yafo (IL)

(21) Appl. No.: 18/969,297

(22) Filed: Dec. 5, 2024

(51) Int. Cl. B60W 60/00

(52) U.S. Cl. CPC B60W 60/001

(57) ABSTRACT

A method for real time predictive driving maneuver assist for autonomous driving applications. The method includes identifying a location of an expected driving maneuver in a driving path of a vehicle, wherein the expected driving maneuver is associated with a scenario in the driving path of the vehicle; collecting statistical data pertaining to artificial intelligence models activated, in a driving of vehicles, in accordance with the scenario; obtaining environmental information regarding an environment of the driving of the vehicle; and determining, in real-time and before the vehicle reaching the location of the expected driving maneuver, by processing the collected statistical data with the environmental information in accordance with the scenario, a set of artificial intelligence models to provide a decision making for assisting with the expected driving maneuver when the vehicle reaches the location of the expected driving maneuver.

### BACKGROUND

Vehicles perform driving maneuvers such as but not limited turns on a daily basis.

A vehicle perform driving maneuver related decisions very quickly and accurately in order to secure the safety of the vehicle.

There is a growing need to provide a solution that will enable the vehicle to perform driving maneuver related decisions very quickly and accurately in order to secure the safety of the vehicle.

### SUMMARY

There may be provided a method, system and computer readable medium for real time predictive driving maneuver assist for autonomous driving applications.

### BRIEF DESCRIPTION OF THE DRAWINGS

The embodiments of the disclosure will be understood and appreciated more fully from the following detailed description, taken in conjunction with the drawings in which:

FIG. 1A illustrates a computerized system;

FIG. 1B illustrates an example of a vehicle;

FIG. 1C illustrates an example of a method;

FIG. 1D illustrates an example of a method;

FIG. 1E illustrates an example of a method;

FIG. 1F illustrates an example of a method;

FIG. 2 illustrates an example of a selection of artificial intelligence models by a perception router;

FIG. 3 illustrates a path, locations and statistical information;

FIG. 4A illustrates an example of a vehicle and its environment;

FIG. 4B illustrates an example of a vehicle and its environment; and

FIG. 4C illustrates an example of a vehicle and its environment.

### DESCRIPTION OF EXAMPLE EMBODIMENTS

The different figures illustrates examples of units and/or software and/or information items and/or steps and/or components. These examples are provided for brevity of explanation. At least one of the units and/or software and/or information items and/or steps and/or components is optional or mandatory.

The term obtaining include receiving and/or generating.

According to an embodiment a scenario (such as a driving scenario) includes at least one of (a) one or more weather conditions, (b) one or more contextual parameters, (c) a road condition, (d) a traffic parameter. Various examples of a road condition may include the roughness of the road, the maintenance level of the road, presence of potholes or other related road obstacles, whether the road is slippery, covered with snow or other particles. Various examples of a traffic parameter and the one or more contextual parameters may include time (hour, day, period or year, certain hours at certain days, and the like), a traffic load, a distribution of vehicles on the road, the behavior of one or more vehicles (aggressive, calm, predictable, unpredictable, and the like), the presence of pedestrians near the road, the presence of pedestrians near the vehicle, the presence of pedestrians away from the vehicle, the behavior of the pedestrians (aggressive, calm, predictable, unpredictable, and the like), risk associated with driving within a vicinity of the vehicle, complexity associated with driving within of the vehicle, the presence (near the vehicle) of at least one out of a kindergarten, a school, a gathering of people, and the like. A contextual parameter may be related to the context of the sensed information—context may be depending on or relating to the circumstances that form the setting for an event, statement, or idea.

AI stands for artificial intelligence. In some of the figures and for brevity of explanation the artificial intelligence models are referred to as AI models.

According to an embodiment, there is provided a solution that is responsive to a scenario and may also be responsive to a combination of a scenario and a road segment in which the vehicle is located.

According to an embodiment, artificial intelligence models implement skills that are dynamically learnt.

According to an embodiment, an artificial intelligence model is associated with a single scenario, different artificial intelligence model are associated with different scenarios.

According to an embodiment, a single scenario is associated with one or more artificial intelligence models.

According to an embodiment, there is provided a method for real time predictive driving maneuver assist for autonomous driving applications, the method includes:
Obtaining environmental information regarding an environment of the driving of the vehicle.
Identifying a location of an expected driving maneuver in a driving path of a vehicle, wherein the expected driving maneuver is associated with a scenario in the driving path of the vehicle.
Collecting statistical data pertaining to artificial intelligence models activated, in a driving of vehicles, in accordance with the scenario.
Determining, in real-time and before the vehicle reaching the location of the expected driving maneuver, by processing the collected statistical data with the environmental information in accordance with the scenario, a set of artificial intelligence models to provide a decision making for assisting with the expected driving maneuver when the vehicle reaches the location of the expected driving maneuver.

According to an embodiment, a driving maneuver includes changing a direction of progress of the vehicle and/or changing a velocity of the vehicle.

According an embodiment, a driving maneuver is executed with the expected or defined path of the vehicle—for example—despite the driving maneuver, the vehicle progresses along the expected or defined path—for example along the same road segments. This may include changing a lane or maintaining the lane associated with the path.

According an embodiment, a driving maneuver involves changing the expected or defined path of the vehicle—for example—applying a driving maneuver that changes at least one expected or defined path segment. For example—assuming that the expected or defined path included applying a driving maneuver that included turning to the right and enter a specified road segment—and the driving maneuver eventually involved skipping the turn—resulting in a change of the path.

According to an embodiment the expected or defined path was provided in a road lane resolution—and a maneuver that required to change a lane altered the path.

Assuming that the maneuver is a turning of the vehicle—then the altering of the path is an example of a driving maneuver and may include at least one out of changing the path (when reaching a turn) by changing a speed, an acceleration, a deceleration, a direction, skipping the turn, avoiding from skipping the turn, slowing the vehicle, increasing the speed of the vehicle, slowing down the vehicle until the objects are far enough and/or outside the trajectory of the vehicle.

According to an embodiment, the driving maneuvers includes at least one of:
Exiting a highway or any other road.
Entering a highway or any other road.
Changing a lane.
Bypassing an obstacle.
Driving over an obstacle.
Entering a roundabout.
Exiting a roundabout.
turning.

According to an embodiment, the determining is followed by responding to the determining. According to an embodiment, the responding includes activating at least one artificial intelligence model of the determined set when reaching the location of the expected scenario.

According to an embodiment the obtaining of the environmental information, and the identifying of the location are executable in an order.

According to an embodiment, the identifying of the location of the expected driving maneuver is based on a location of the vehicle and on an expected path of the vehicle.

The expected path may be known—for example, when the path of the vehicle is provided (by a driver of the vehicle, by a passenger of the vehicle, by a path planning entity that plans the path), or estimated—for example based on the target, based on a statistic distributions of paths followed by vehicles (any vehicle, the current vehicle, vehicles of the same type and model). The statistic distribution may take into account one or more factors such as the timing of the driving (hour or day and hour, and or weekend or weekday, holiday or not). For example—estimating the path to be the most popular path under the circumstances (time, identity of driver, identity of passenger, and the like).

According to an embodiment, the location of the vehicle is based, at least in part, on the environmental information.

According to an embodiment, the determining of the location of the vehicle is made based on a location related sensor such as global satellite system (SGPS) sensor, a cellular network location sensor (such as a cellular receiver included in the vehicle and/or included in a mobile phone or other communication devices of the driver or passenger) and/or a communication devices which is communication with any other (non-satellite) aerial sensor.

According to an embodiment the environmental information is provided by an environmental information sensor and is used to verify the location of the vehicle generated by a location related sensor that differs from the environmental information sensor.

According to an embodiment, the environmental information sensor is selected out of a visual sensor, an infrared sensor, an acoustic sensor, a radar, a sonar, a color sensor, an active sensor (such as a LIDAR), a passive sensor, and the like. The radiation sensed by the one or more environmental information sensors may be of any frequency and/or bandwidth.

According to an embodiment the environmental information sensor and/or the location related sensor is within the vehicle or belongs to the vehicle and extends at least in part outside the vehicle, is temporarily located within the vehicle, associated with a driver or passenger, and the like.

According to an embodiment the environmental information sensor and/or the location related sensor is located outside the vehicle and not solely associated with the vehicle.

According to an embodiment, the expected driving maneuver is associated with a scenario in the driving path of the vehicle.

According to an embodiment, the scenario is associated with the location based on behaviors of one or more vehicles that reaches the location. The associated may be determined during a learning period of any duration and/or is related to any number of vehicles. For example—behaviors of one hundred to one hundred thousand vehicle over a period of one day till one year.

According to an embodiment, the expected driving maneuver is identified in various manners. For example—the identifying may be based, at least in part, on maps or equivalent information regarding an environment of the vehicle, on location information regarding the location of the vehicle, on information sensed by the vehicle (for example images of a turn or other scenario that requires a response, an image of traffic sign indicative of a turn) and the like.

According to an embodiment, a timing in which the vehicle will reach the location of the expected driving maneuver is determined based the location of the expected driving maneuver, the location of the vehicle and a progress parameter of the vehicle such as a speed, an average speed during the last period of time (between 10 seconds and 1 hour), acceleration (such as a current acceleration, an average acceleration), a profile of the vehicle and/or a profile of the driver that maps progress parameters to the environment, one or more traffic laws or regulations (such maximal and/or minimal speed), weather conditions (rain and/or fog and/or snow and/or lack of light impose a slower progress in comparison to a sunny day with perfect visibility conditions).

According to an embodiment, the determining, in real-time and before the vehicle reaching the location of the expected driving maneuver, of a set of artificial intelligence models to provide a decision making for assisting with the expected driving maneuver when the vehicle reaches the location of the expected driving maneuver—ia based on an association between the expected driving maneuver and the scenario at the location of the expected driving maneuver.

According to an embodiment, the selection of one or more artificial intelligence models according to a scenario is made by a perception router, an example of which is provided in either one of U.S. patent application Ser. No. 18/036,150 or U.S. patent application Ser. No. 17/445,312—each being incorporated herein by reference.

Any reference to the selection of the one or more artificial intelligence models should be applied mutandis mutandis to selection of the one or more artificial intelligence models based on the collected statistical data with the environmental information in accordance with the scenario.

According to an embodiment, the environmental information is indicative of the scenario.

According to an embodiment, the collected statistical data pertaining to artificial intelligence models activated, in a driving of vehicles, in accordance with the scenario is used for selecting, given the driving of the scenario, the one or more artificial intelligence models.

For example—assuming that one or more of the scenario itself and the collected statistical data is responsive to the location—the combination of the scenario and the collected statistical data (and the implicit or explicit location) is used to determine which one or more artificial intelligence models to select for applying at the location of the expected driving maneuver—for example the most commonly one or more artificial intelligence models selected at the location when facing the scenario. For example—assuming that the expected driving maneuver is turning to the right and at a given location, according to the vehicle path, has to turn to the right—then the determine which one or more artificial intelligence models to select is based on statistical data related to the given location.

Yet for another example—according to an embodiment—assuming that the most commonly one or more artificial intelligence models selected by a vehicle of the same model and/or year as the vehicle executing the selection—at the location when facing the scenario.

For example—assuming the scenario itself and the collected statistical data are responsive to the location—the combination of the scenario and the collected statistical data (even without taking into account the location itself) is used to determine which one or more artificial intelligence models to select for applying at the location of the expected driving maneuver—for example the most commonly one or more artificial intelligence models selected at the location when facing the scenario. For example assuming that the expected driving maneuver is turning to the right—and at a given location, according to the vehicle path, has to turn to the right—then the determine which one or more artificial intelligence models to select is based on statistical data related to turning to the right—as there is no link to the given location.

According to an embodiment, the determining of the scenario includes generating a scenario signature, and comparing the scenario signature to reference signature that are indicative of reference scenarios—to identify a scenario signature, generated in association with the scenario, that matches the environmental information associated with the scenario. The signature may be an embedding, a signature of an embedding, not related to an embedding, may be based on a cropped image, and the like. An example of embeddings is illustrated in U.S. patent application Ser. No. 18/527,701 which is incorporated herein by reference.

According to an embodiment, the accuracy of the execution of the driving maneuver is improved by dynamically obtaining environmental information and dynamically determining how to respond—for example by dynamically selecting one or more artificial intelligence models.

According to an embodiment, the dynamically obtaining of the environmental information includes obtaining additional environmental information before a completion of the expected driving maneuver; and selecting a selected artificial intelligence model of the determined set of artificial intelligence models further based on the additional environmental information.

According to an embodiment, the accuracy of the execution of the driving maneuver is improved by obtaining additional environmental information regarding the location of the expected driving maneuver, and verifying that the determined set of artificial intelligence models are relevant to the location of the expected driving maneuver. According to an embodiment, the verifying includes using a mapping between the scenario (determined based also on the additional environmental information) and the determined set of artificial intelligence models—as the additional environment information may alter or at least fine tune the scenario. For example—detecting one or more objects that may require to adjust the driving maneuver.

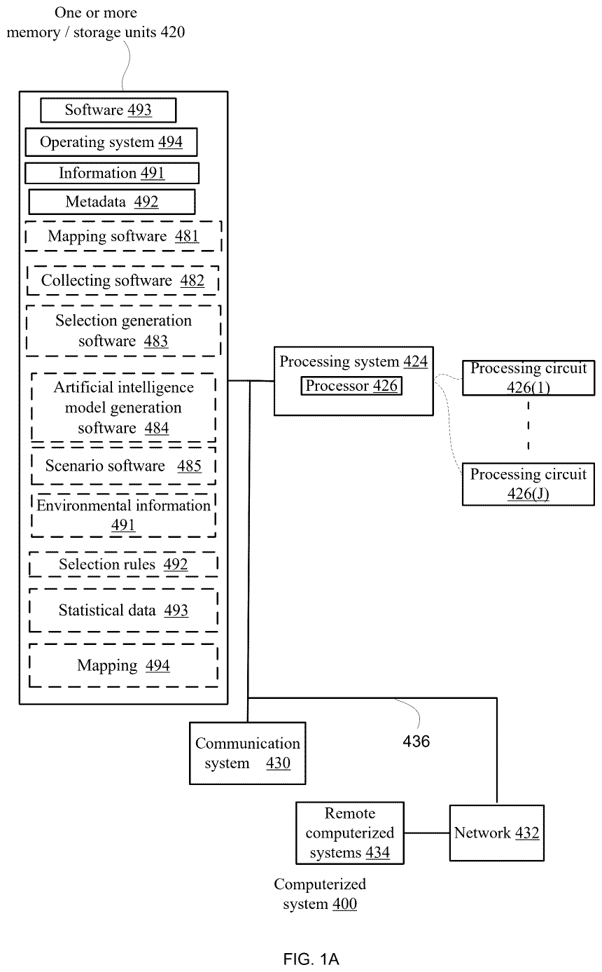

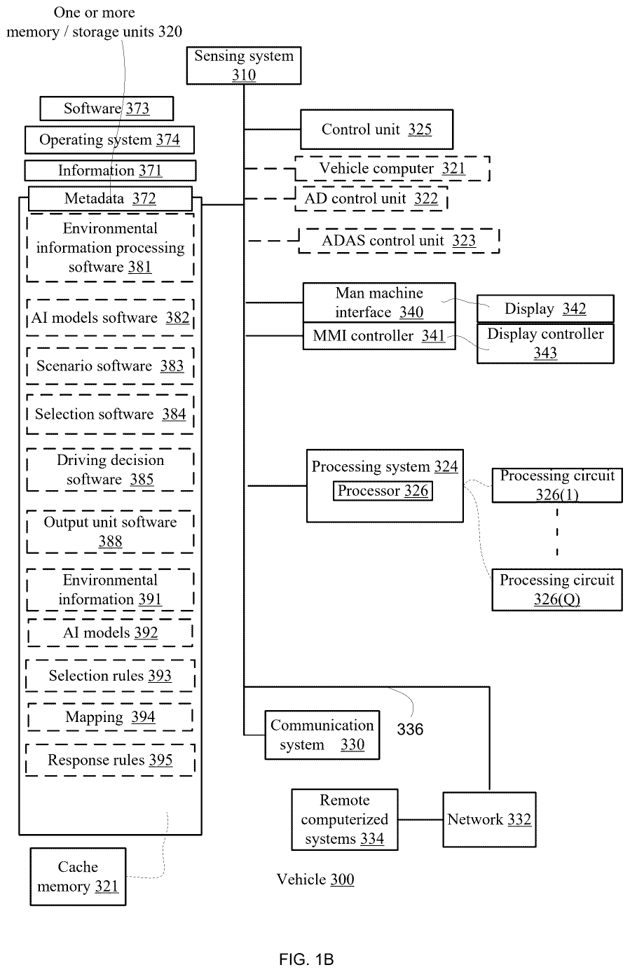

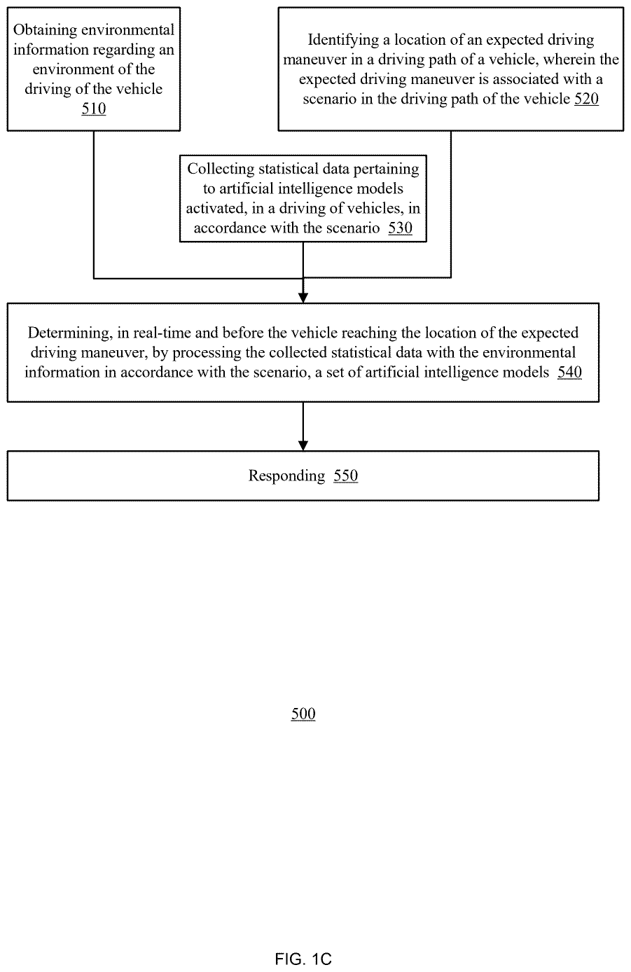

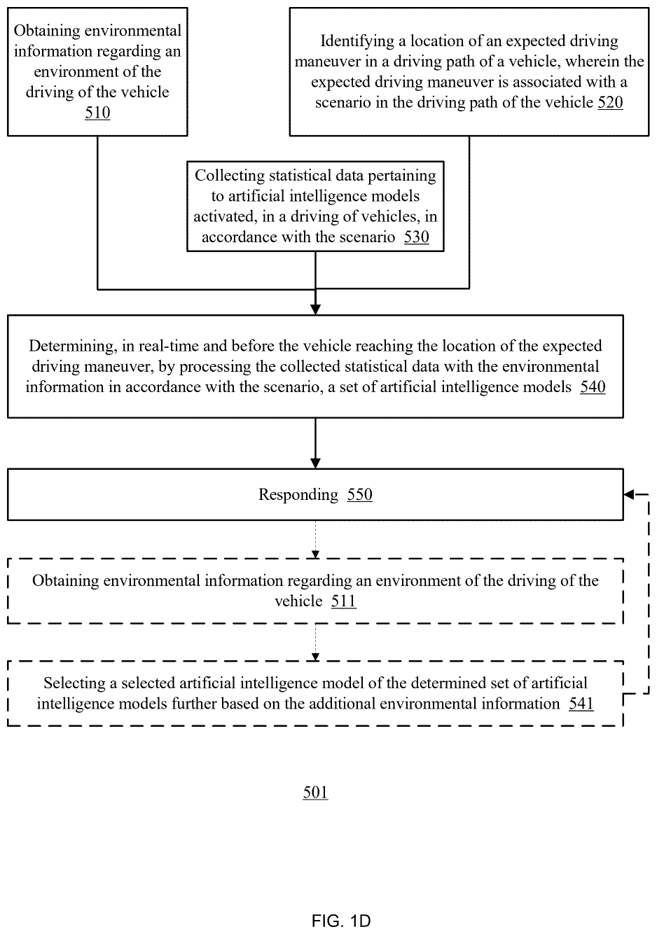

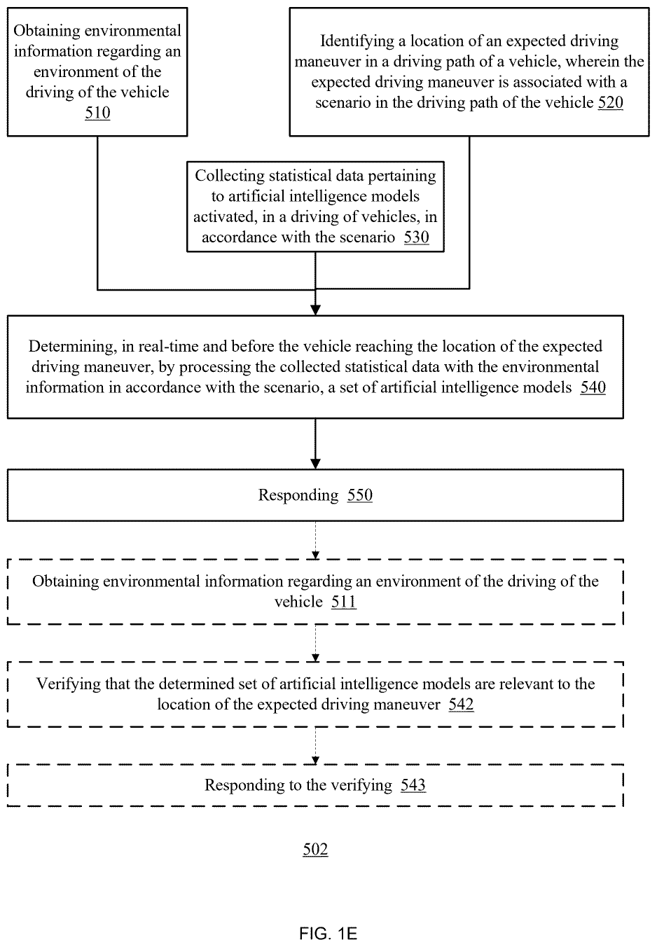

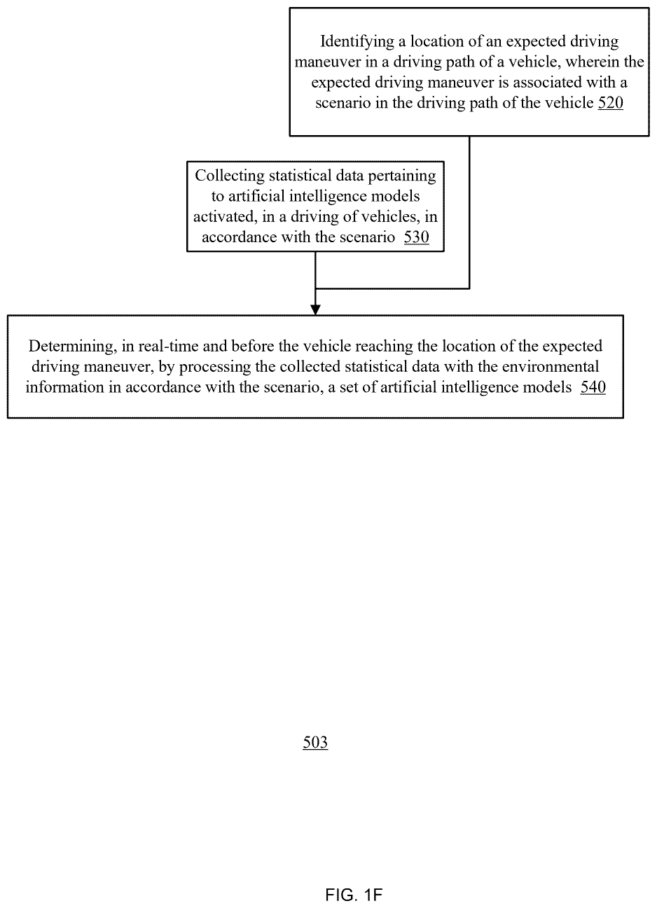

FIG. 1A illustrates an example of a computerized system 400.

Computerized system 400 includes a man machine interface 440 having or being in communication with man machine interface (MMI) controller (not shown), a communication system 430, one or more memory and/or storage units 420, a processing system 424 including processor 426. The computerized system may be a server, a laptop, a desktop or any other computer and may include or be in communication with a sensing unit and/or a controller.

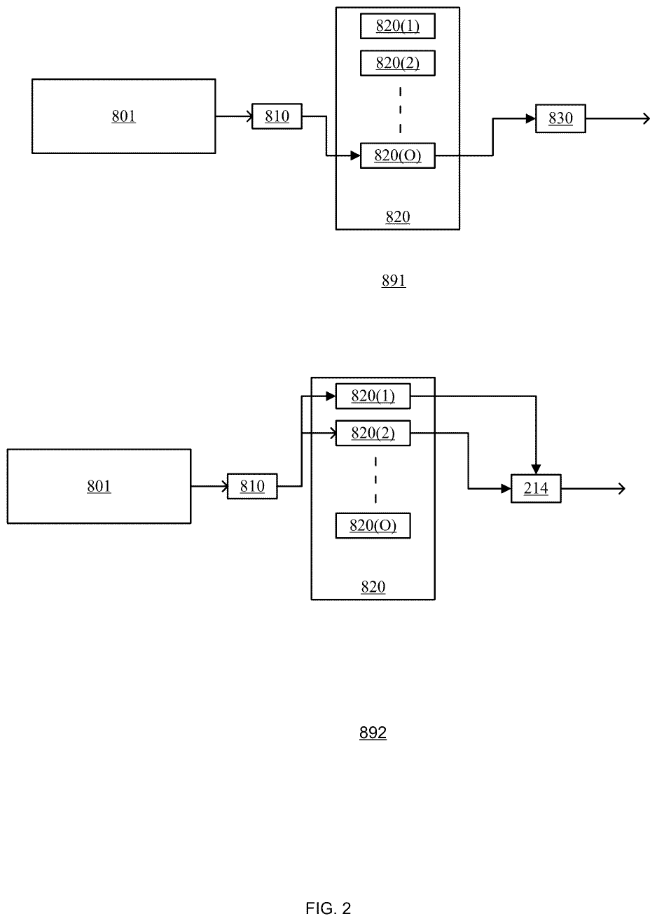

According to an embodiment, computerized system 400 is in communication with network 432 and one or more other remote computerized systems 434 that are in communication with network 432. An example of a remote computerized system is a vehicle (such as vehicle 300 of FIG. 2), a server or one or more computers having access to a storage system.

According to an embodiment, the communication system 430 is configured to enable communication between the one or more memory and/or storage units 420 and/or any one of the additional units and/or the network 432 (that is in communication with the remote computerized systems). Communication system 430 is also configured to enable communication with other elements such as man machine interface 440.

The memory and/or storage units 420 was shown as storing software. Any reference to software should be applied mutatis mutandis to code and/or firmware and/or instructions and/or commands, and the like.

Processor 426 includes a plurality of processing units 426(1)-426(J), J is an integer that exceeds one. Any reference to one unit or item should be applied mutatis mutandis to multiple units or items. For example—any reference to processor should be applied mutatis mutandis to multiple processors, any reference to communication system 430 should be applied mutatis mutandis to multiple communication systems.

According to an embodiment, the one or more memory and/or storage units 420 includes one or more memory unit, each memory unit may include one or more memory banks.

According to an embodiment, the one or more memory and/or storage units 420 includes a volatile memory and/or a non-volatile memory. The one or more memory and/or storage units 420 may be a random-access memory (RAM) and/or a read only memory (ROM).

According to an embodiment, the non-volatile memory unit is a mass storage device, which can provide non-volatile storage of computer code, computer readable instructions, data structures, program modules, and other data for the processor or any other unit of vehicle. For example, and not meant to be limiting, a mass storage device can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any content may be stored in any part or any type of the memory and/or storage units.

According to an embodiment, the at least one memory unit stores at least one database—such as any database known in the art—such as DB2®, Microsoft® Access, Microsoft® SQL Server, Oracle®, mySQL, PostgreSQL, and the like.

The memory and/or storage units 420 are configured to store firmware and/or software, one or more operating systems, data and metadata required to the execution of any of the methods mentioned in this application.

The memory and/or storage units 420 was shown as storing software. Any reference to software should be applied mutatis mutandis to code and/or firmware and/or instructions and/or commands, and the like.

Various units and/or components are in communication with each other using any communication elements and/or protocols. An example of a communication system is denoted 430. Other communication elements may be provided.

The communication system 430 may be in communication with bus 436. The bus represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus, and all buses specified in this description can also be implemented over a wired or wireless network connection and each of the subsystems.

Network 432 that is located outside the computerized system and is used for communication between the computerized system and at least one remote computing system and/or one or more vehicles. By way of example, a remote computing system can be a personal computer, a laptop computer, portable computer, a server, a router, a network computer, a peer device or other common network node, and so on. Logical connections between the processor and either one of remote computing systems can be made via a local area network (LAN) and a general wide area network (WAN). Such network connections can be through a network adapter (may belong to communication system 430) which can be implemented in both wired and wireless environments. Such networking environments are conventional and commonplace in offices, enterprise-wide computer networks, intranets, and a larger network such as the internet.

It should be noted that at least a part of the content illustrated as being stored in one or more memory/storage units 420 may be stored outside the computerized system. It should also be noted that the processor may evaluate signatures generated by a plurality of detectors.

Examples of generating signatures and/or cropping images are provided in U.S. patent application Ser. No. 18/527,701 which is incorporated herein by reference.

According to an embodiment, the memory and/or storage units 420 stores at least one of operating system 474, information 471, metadata 472, and software 473.

Examples of software include at least one of:
Mapping software 481 for generate a mapping between driving paths, scenarios expected at different locations of the driving paths and expected driving maneuvers at the different locations.
Collecting software 482 for collecting statistical data pertaining to artificial intelligence models activated, in a driving of vehicles, in accordance with the scenarios at the different locations.
Selection generation software 483 for generating selection rules for determining how vehicles should select sets of artificial intelligence models in real time and before reaching the different locations, based on the collected statistical data with environmental information in accordance with corresponding scenarios.
Artificial intelligence model generation software 484 for generating the artificial intelligence models of multiple sets of set of artificial intelligence models.
Scenario software 485 for detecting a scenario.

Only one or some of these software may be stored in the one or more memory/storage units 420. There may be an overlap between the functionality of one or more of these software.

Examples of information and/or metadata include at least one of environmental information 491, selection rules 492, statistical data 493, and mapping 494 between driving paths, scenarios expected at different locations of the driving paths and expected driving maneuvers at the different locations. Only one or some of these information and/or metadata may be stored in the one or more memory/storage units 420.

By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by a computer.

Any content may be stored in any part or any type of memory and/or storage units.

According to an embodiment, at least one memory unit stores at least one database—such as any database known in the art—such as DB2®, Microsoft® Access, Microsoft® SQL Server, Oracle®, mySQL, PostgreSQL, and the like.

Various units and/or components are in communication with each other using any communication elements and/or protocols. An example of a communication system is denoted 430. Other communication elements may be provided.

According to an embodiment, processing system 424 is configured to perform method 700 while executing software.

According to an embodiment, processing system 424 is configured to perform at least one of the following when executing software:
Generate a mapping between driving paths, scenarios expected at different locations of the driving paths and expected driving maneuvers at the different locations.
Collect statistical data pertaining to artificial intelligence models activated, in a driving of vehicles, in accordance with the scenarios at the different locations.
Determine how vehicles should select sets of artificial intelligence models in real time and before reaching the different locations, based on the collected statistical data with environmental information in accordance with corresponding scenarios.

FIG. 1B illustrates an example of vehicle 300.

Vehicle 300 includes a man machine interface 340 having or being in communication with man machine interface (MMI) controller 341, wherein in FIG. 1 the MMI is a display 342 or includes a display 342 and the MMI controller is a display controller 343 or includes the display controller 343, a communication system 330, one or more memory and/or storage units 320, a processing system 324 including processor 326. The communication system 330, the one or more memory and/or storage units 320, and the processing system 324 may belong to a computerized system of vehicle 300. The computerized system may be a server, a laptop, a desktop or any other computer and may include or be in communication with a sensing unit and/or a controller.

According to an embodiment, vehicle 300 is in communication with network 332 and one or more other remote computerized systems 334 that are in communication with network 332. An example of a remote computerized system is a server or one or more computers having access to a storage system that stores items related to one or more portions of one or more groups of neural networks—at least some of which are not currently stored in the vehicle.

According to an embodiment, the communication system 330 is configured to enable communication between the one or more memory and/or storage units 320 and/or any one of the additional units and/or the network 332 (that is in communication with the remote computerized systems). Communication system 330 is also configured to enable communication with other elements such as sensing system 310, man machine interface 340, control unit 325, vehicle computer 321, autonomous driving control unit 322 (denoted AD control unit), advanced driver assistance system (ADAS) control unit 323 (denoted ADAS control unit), and the like.

The memory and/or storage units 320 was shown as storing software. Any reference to software should be applied mutatis mutandis to code and/or firmware and/or instructions and/or commands, and the like.

Processor 326 includes a plurality of processing units 326(1)-326(Q), Q is an integer that exceeds one. Any reference to one unit or item should be applied mutatis mutandis to multiple units or items. For example—any reference to processor should be applied mutatis mutandis to multiple processors, any reference to communication system 330 should be applied mutatis mutandis to multiple communication systems.

According to an embodiment, the one or more memory and/or storage units 320 includes one or more memory unit, each memory unit may include one or more memory banks.

Any reference to memory and/or storage units 420 should be applied mutatis mutandis to one or more memory and/or storage units 320.

Any reference to communication system 430 should be applied mutatis mutandis to communication system 330.

Any reference to bus 436 should be applied mutatis mutandis to bus 336.

Any reference to network 432 should be applied mutatis mutandis to network 332.

According to an embodiment, the memory and/or storage units 320 stores at least one of: operating system 374, information 371, metadata 372, and software 373.

According to an embodiment, the memory and/or storage units 420 stores at least one of operating system 474, information 471, metadata 472, and software 473.

Examples of software include at least one of environmental information processing software 381 (for processing the environmental information), artificial intelligence model software 382, for implementing the artificial intelligence models, scenario software 383 for determining the scenario based on the environmental information, selection software 384 for selecting the sets of the artificial intelligence model, response output unit software 388 for implementing the output unit that follows the artificial intelligence models.

Only one or some of these software may be stored in the one or more memory/storage units 320. There may be an overlap between the functionality of one or more of these software.

Examples of information and/or metadata include at least one or more of environmental information 391, artificial intelligence models 392, selection rules 393, mapping 394, and response rules 395. Only one or some of these information and/or metadata may be stored in the one or more memory/storage units 320.

The one or more memory/storage units 320 also includes cache memory 321.

The control unit 325 may cooperate with ADAS control unit 323 and/or with AD control unit 322 and/or may control or communicate with other vehicle components—including vehicle computer.

The ADAS control unit 323 is configured to control ADAS operations.

The AD control unit 322 is configured to control autonomous driving of the autonomous vehicle.

The vehicle computer 321 is configured to control the operation of the vehicle—especially controlling the engine, the transmission, and any other vehicle system or component.

The vehicle computer 321 may be in communication with an engine control module, a transmission control module, a powertrain control module, and the like.

The sensing system 310 may include optics, a sensing element group, a readout circuit, and an image signal processor. Optics are followed by a sensing element group such as line of sensing elements or an array of sensing elements that form the sensing element group. The sensing element group is followed by a readout circuit that reads detection signals generated by the sensing element group. An image signal processor is configured to perform an initial processing of the detection signals—for example by improving the quality of the detection information, performing noise reduction, and the like. The sensing system 310 is configured to output one or more sensed information units (SIUs) such as images, frames, audio segments, and any segment of unit of any sensed information unit.

Control unit 325 is configured to control the operation of the sensing system 310, and/or the one or more memory and/or storage units 320 and/or the one or more additional units (except the controller).

By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information, and which can be accessed by a computer.

Any content may be stored in any part or any type of memory and/or storage units.

According to an embodiment, at least one memory unit stores at least one database—such as any database known in the art—such as DB2®, Microsoft® Access, Microsoft® SQL Server, Oracle®, mySQL, PostgreSQL, and the like.

Various units and/or components are in communication with each other using any communication elements and/or protocols. An example of a communication system is denoted 330. Other communication elements may be provided.

According to an embodiment, processing system 324 is configured to perform method 500, while executing software.

According to an embodiment, processing system 324 is configured to perform, while executing software:
Identify a location of an expected driving maneuver in a driving path of a vehicle, wherein the expected driving maneuver is associated with a scenario in the driving path of the vehicle.
Collect statistical data pertaining to artificial intelligence models activated, in a driving of vehicles, in accordance with the scenario.
Obtain environmental information regarding an environment of the driving of the vehicle.
Determine, in real-time and before the vehicle reaching the location of the expected driving maneuver, by processing the collected statistical data with the environmental information in accordance with the scenario, a set of artificial intelligence models to provide a decision making for assisting with the expected driving maneuver when the vehicle reaches the location of the expected driving maneuver.

FIG. 1C illustrates an example of method 500 for real time predictive driving maneuver assist for autonomous driving applications.

According to an embodiment, method 500 includes step 510 of obtaining environmental information regarding an environment of the driving of the vehicle.

According to an embodiment, the environmental information sensor is selected out of a visual sensor, an infrared sensor, an acoustic sensor, a radar, a sonar, a color sensor, an active sensor (such as a LIDAR), a passive sensor, and the like. The radiation sensed by the one or more environmental information sensors may be of any frequency and/or bandwidth.

According to an embodiment, method 500 includes step 520 of identifying a location of an expected driving maneuver in a driving path of a vehicle, wherein the expected driving maneuver is associated with a scenario in the driving path of the vehicle.

According to an embodiment, step 520 is based on a location of the vehicle and on an expected path of the vehicle.

According to an embodiment, the expected path is known—for example, when the path of the vehicle is provided (by a driver of the vehicle, by a passenger of the vehicle, by a path planning entity that plans the path), or estimated—for example based on the target, based on a statistic distributions of paths followed by vehicles (any vehicle, the current vehicle, vehicles of the same type and model). The statistic distribution may take into account one or more factors such as the timing of the driving (hour or day and hour, and or weekend or weekday, holiday or not). For example—estimating the path to be the most popular path under the circumstances (time, identity of driver, identity of passenger, and the like).

According to an embodiment, the location of the vehicle is based, at least in part, on the environmental information.

According to an embodiment, the determining of the location of the vehicle is made based on a location related sensor such as global satellite system (SGPS) sensor, a cellular network location sensor (such as a cellular receiver included in the vehicle and/or included in a mobile phone or other communication devices of the driver or passenger) and/or a communication devices which is communication with any other (non-satellite) aerial sensor.

According to an embodiment the environmental information is provided by an environmental information sensor and is used to verify the location of the vehicle generated by a location related sensor that differs from the environmental information sensor.

According to an embodiment, step 510 and 520 are executable in any order.

According to an embodiment the environmental information sensor and/or the location related sensor is within the vehicle or belongs to the vehicle and extends at least in part outside the vehicle, is temporarily located within the vehicle, associated with a driver or passenger, and the like.

According to an embodiment the environmental information sensor and/or the location related sensor is located outside the vehicle and not solely associated with the vehicle.

According to an embodiment, the expected driving maneuver is associated with a scenario in the driving path of the vehicle.

According to an embodiment, the scenario is associated with the location based on behaviors of one or more vehicles that reaches the location. The associated may be determined during a learning period of any duration and/or is related to any number of vehicles. For example—behaviors of one hundred to one hundred thousand vehicle over a period of one day till one year.

According to an embodiment, the expected driving maneuver is identified in various manners. For example—the identifying may be based, at least in part, on maps or equivalent information regarding an environment of the vehicle, on location information regarding the location of the vehicle, on information sensed by the vehicle (for example images of a turn or other scenario that requires a response, an image of traffic sign indicative of a turn) and the like.

According to an embodiment, a timing in which the vehicle will reach the location of the expected driving maneuver is determined based the location of the expected driving maneuver, the location of the vehicle and a progress parameter of the vehicle such as a speed, an average speed during the last period of time (between 10 seconds and 1 hour), acceleration (such as a current acceleration, an average acceleration), a profile of the vehicle and/or a profile of the driver that maps progress parameters to the environment, one or more traffic laws or regulations (such maximal and/or minimal speed), weather conditions (rain and/or fog and/or snow and/or lack of light impose a slower progress in comparison to a sunny day with perfect visibility conditions).

According to an embodiment, method 500 includes step 530 of collecting statistical data pertaining to artificial intelligence models activated, in a driving of vehicles, in accordance with the scenario. The collecting may include or may be replaced by receiving and/or retrieving and/or generating. And the like.

According to an embodiment, steps 510, 520 and 530 are followed by step 540 of determining, in real-time and before the vehicle reaching the location of the expected driving maneuver, by processing the collected statistical data with the environmental information in accordance with the scenario, a set of artificial intelligence models to provide a decision making for assisting with the expected driving maneuver when the vehicle reaches the location of the expected driving maneuver.

According to an embodiment, the determining, in real-time and before the vehicle reaching the location of the expected driving maneuver, of a set of artificial intelligence models to provide a decision making for assisting with the expected driving maneuver when the vehicle reaches the location of the expected driving maneuver—is based on an association between the expected driving maneuver and the scenario at the location of the expected driving maneuver.

According to an embodiment, the selection of one or more artificial intelligence models according to a scenario is made by a perception router, an example of which is provided in either one of U.S. patent application Ser. No. 18/036,150 or U.S. patent application Ser. No. 17/445,312—each being incorporated herein by reference.

Any reference to the selection of the one or more artificial intelligence models should be applied mutatis mutandis to selection of the one or more artificial intelligence models based on the collected statistical data with the environmental information in accordance with the scenario.

According to an embodiment, the environmental information is indicative of the scenario.

According to an embodiment, the collected statistical data pertaining to artificial intelligence models activated, in a driving of vehicles, in accordance with the scenario is used for selecting, given the driving of the scenario, the one or more artificial intelligence models.

For example—assuming that one or more of the scenario itself and the collected statistical data is responsive to the location—the combination of the scenario and the collected statistical data (and the implicit or explicit location) is used to determine which one or more artificial intelligence models to select for applying at the location of the expected driving maneuver—for example the most commonly one or more artificial intelligence models selected at the location when facing the scenario. For example—assuming that the expected driving maneuver is turning to the right and at a given location, according to the vehicle path, has to turn to the right—then the determine which one or more artificial intelligence models to select is based on statistical data related to the given location.

Yet for another example—according to an embodiment—assuming that the most commonly one or more artificial intelligence models selected by a vehicle of the same model and/or year as the vehicle executing the selection—at the location when facing the scenario.

For example—assuming the scenario itself and the collected statistical data are responsive to the location—the combination of the scenario and the collected statistical data (even without taking into account the location itself) is used to determine which one or more artificial intelligence models to select for applying at the location of the expected driving maneuver—for example the most commonly one or more artificial intelligence models selected at the location when facing the scenario. For example assuming that the expected driving maneuver is turning to the right—and at a given location, according to the vehicle path, has to turn to the right—then the determine which one or more artificial intelligence models to select is based on statistical data related to turning to the right—as there is no link to the given location.

According to an embodiment, the determining of the scenario includes generating a scenario signature, and comparing the scenario signature to reference signature that are indicative of reference scenarios—to identify a scenario signature, generated in association with the scenario, that matches the environmental information associated with the scenario. The signature may be an embedding, a signature of an embedding, not related to an embedding, may be based on a cropped image, and the like. An example of embeddings is illustrated in U.S. patent application Ser. No. 18/527,701 which is incorporated herein by reference.

According to an embodiment, the accuracy of the execution of the driving maneuver is improved by dynamically obtaining environmental information and dynamically determining how to respond—for example by dynamically selecting one or more artificial intelligence models.

According to an embodiment, the dynamically obtaining of the environmental information includes obtaining additional environmental information before a completion of the expected driving maneuver; and selecting a selected artificial intelligence model of the determined set of artificial intelligence models further based on the additional environmental information.

FIG. 1D illustrates method 501 that also includes step 511 of obtaining additional environmental information before a completion of the expected driving maneuver and step 541 of selecting a selected artificial intelligence model of the determined set of artificial intelligence models further based on the additional environmental information. Step 541 may be followed by step 550 of responding.

For example—assuming that the scenario is approaching an exit of a highway where the expected or specified path of the vehicle involved exiting the highway at that highway exit.

According to an embodiment step 511 includes obtaining environmental information that was not previously within the field of view of any related sensor—for example—additional environmental information regarding the condition following the exit—for example the existence or lack of existence of an obstacle and/or of a vehicle stuck after the highway exit and/or of the traffic after the highway exit—a traffic jam, slow traffic, vacant or high speed progressing traffic and the like, weather conditions after the highway exit (heavy rain and/or fog and strong winds and/or floods)—and executing step 541 resulting in applying either maintaining the current set of artificial intelligence models or changing at least one artificial intelligence models—for example to a artificial intelligence model that is trained to cope with content represented by the additional environmental information. For example—instead of using a artificial intelligence model trained to operate at sunny conditions (assuming the existence of sunny conditions before exiting the highway)—using an artificial intelligence model trained to operate at heavy rain conditions (assuming the existence of heavy rain following the highway exit).

According to an embodiment the response to the additional environmental information must be quick enough (a fraction of a second) in order to allow the vehicle to skip the highway exit—and the speeding up may be assisted by storing in a cache memory the relevant artificial intelligence models—the set of artificial intelligence models that is used when approaching the highway exit—and optionally one or more sets of alternative artificial intelligence models to be used when step 541 indicates that there is a need to use another set of artificial intelligence models.

According to an embodiment, the accuracy of the execution of the driving maneuver is improved by obtaining additional environmental information regarding the location of the expected driving maneuver, and verifying that the determined set of artificial intelligence models are relevant to the location of the expected driving maneuver. According to an embodiment, the verifying includes using a mapping between the scenario (determined based also on the additional environmental information) and the determined set of artificial intelligence models—as the additional environment information may alter or at least fine tune the scenario. For example—detecting one or more objects that may require to adjust the driving maneuver.

FIG. 1E illustrates method 502 that also includes step 511 of obtaining additional environmental information before a completion of the expected driving maneuver, and step 542 of verifying that the determined set of artificial intelligence models are relevant to the location of the expected driving maneuver. According to an embodiment, step 542 is followed by step 543 of responding to the verifying—for example maintaining to use the verified set of artificial intelligence models—or selecting another set of artificial intelligence models that are relevant to the location of the expected driving maneuver. There may be at least a partial overlap between the unverified set and the other set—but there may be non-overlap between the sets.

According to an embodiment the response to the additional environmental information must be quick enough (a fraction of a second) in order to allow the vehicle to skip the highway exit—and the speeding up may be assisted by storing in a cache memory the relevant artificial intelligence models—the set of artificial intelligence models that is used when approaching the highway exit—and optionally one or more sets of alternative artificial intelligence models to be used when step 542 does not verity the current set of artificial intelligence models.

According to an embodiment, step 540 is followed by step 550 of responding to the outcome of step 540.

According to an embodiment, step 550 includes at least one of:
Activating at least one artificial intelligence model of the determined set when reaching the location of the expected scenario.
Responding to the outcome of the activation of the at least one artificial intelligence model of the determined set—for example the outcome of the decision making.
Generating a driving related output.

According to an embodiment, and assuming that the driving maneuver is turning to the side—the activation of the at least one artificial intelligence model may result in at least one of:
Recalculating the predefined path of the autonomous vehicle when determining that the at least one of the objects is expected to cross the trajectory of the vehicle during the turn.
Skipping the turn when determining that the at least one of the objects is expected to cross the trajectory of the vehicle during the turn.
Calculating a risk associated with altering a movement of the vehicle without skipping the turn, and determining whether to skip the turn based on the risk. The risk may be responsive to the width of the path following the turn, to the environmental condition (rain, visibility, road grip), the size and locations of the vehicle and the object—for example the capability of the vehicle to maneuver away from the objects during the turn given the locations of the objects and/or size of the objects, and the like.
Alerting a driver of the vehicle regarding the chances of a possible collision.
Suggesting to a driver of the vehicle to skip the turn when determining that the at least one of the objects is expected to cross the trajectory of the vehicle during the turn.
Altering a movement of the vehicle without skipping the turn when determining that the at least one of the objects is expected to cross the trajectory of the vehicle during the turn.
Alerting a road user about the expected turn of a vehicle and/or altering of a potential accident.

The driving related output may be provided by one or more artificial intelligence model and/or by the output unit and/or by an application that is downstream to the output unit in the sense that the output of the output unit is provided to the application or is further processed before reaching the application.

According to an embodiment, the driving related output may be the outcome of the special-purpose decision making.

According to an embodiment, the driving related output includes at least one of:
An instruction executable by a man machine interface controller, to provide a recommendation to a driver regarding a navigation of the vehicle.
A request aimed to the man machine interface controller, to provide a recommendation to a driver regarding a navigation of the vehicle.
An instruction executable by an autonomous control unit of the vehicle to perform an autonomous driving related operation such as autonomously changing a speed of the vehicle, autonomously changing an acceleration of the vehicle, autonomously changing an acceleration of the vehicle, autonomously changing a mode of operation of the vehicle.
A request aimed at an autonomous control unit of the vehicle to perform an autonomous driving related operation such as autonomously changing a speed of the vehicle, autonomously changing an acceleration of the vehicle, autonomously changing an acceleration of the vehicle, autonomously changing a mode of operation of the vehicle.
An instruction executable by a driver assistance control unit (such as but not limited to an ADAS control unit) of the vehicle to perform a driver assisting operation—such as suggesting to the driver a suggested path of progress, a suggested speed and/or acceleration and/or direction of the vehicle, or performing an autonomous braking operation or performing a lane maintenance operation of temporarily, during a short period, takeover the control of the vehicle, and the like.
A request aimed to a driver assistance control unit (such as but not limited to an ADAS control unit) of the vehicle to perform a driver assisting operation such as suggesting to the driver a suggested path of progress, a suggested speed and/or acceleration and/or direction of the vehicle, or performing an autonomous braking operation or performing a lane maintenance operation of temporarily, during a short period, takeover the control of the vehicle, and the like.
An instruction executable by a computer vehicle related to a manner of operation of any component of the vehicle such as brakes, engine, and the like.
A request sent to a computer vehicle related to a manner of operation of any component of the vehicle such as brakes, engine, and the like.
Information about the environment of the vehicle.
A prediction of a future path of the vehicle.
A prediction of a behavior of one or more road element.
An emergency alert.
A collision alert.

FIG. 1F illustrates method 503 that differs from method 500 of FIG. 1C by not including steps 510 and 550. Method 503 includes steps 520, 530 and 540. Step 540 is preceded by steps 520 and 530.

FIG. 2 illustrates an example of two activations made at different times by a perception router 810 of two sets of artificial intelligence models (out of artificial intelligence models 820(1)-820(O)) given different inputs (denoted 801 and representing the outcome of steps 510, 520 and 530).

Each set provides one or more outputs to an output unit 830 configured to generate an output to one or more units of the vehicle.

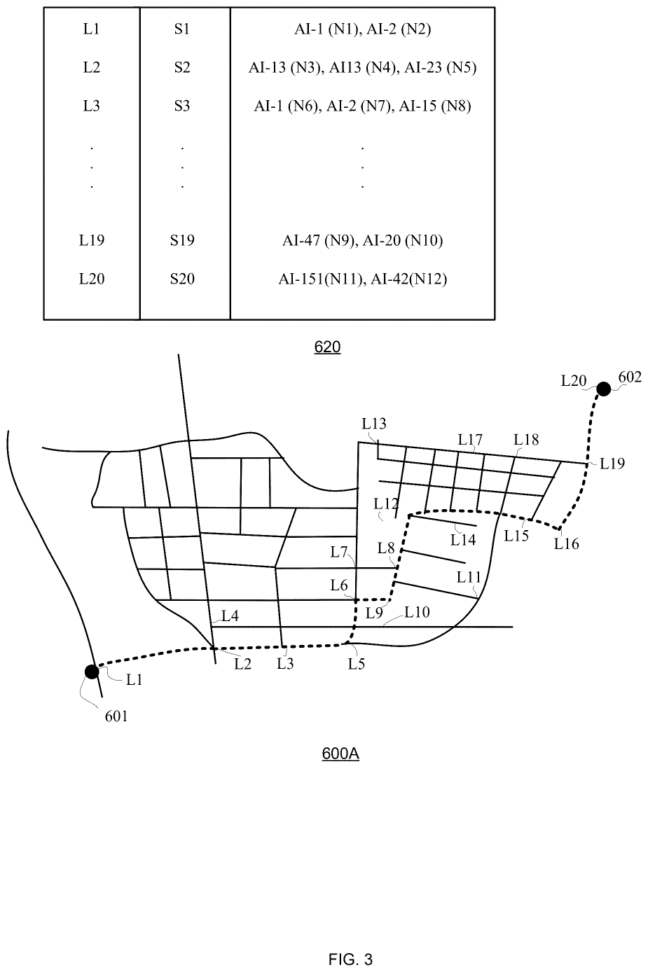

FIG. 3 illustrates an example of mapping 620A that maps a plurality of locations such as L1-L20) to information about activation of artificial intelligence models at the locations. FIG. 3 illustrates that per location, the artificial intelligence models that were activated per location and the number of activations (AI-j (Nk))—whereas j is an identifier of the activated artificial intelligence model and Nk is the number of activations.

FIG. 3 also illustrates a region that includes multiple roads and junctions and an expected path of the vehicle—from starting point 601 to end point 602.

FIG. 3 also illustrates a region that includes multiple roads and junctions, and an expected path (represented by dotted line) of the vehicle—from starting point 601 to end point 602.

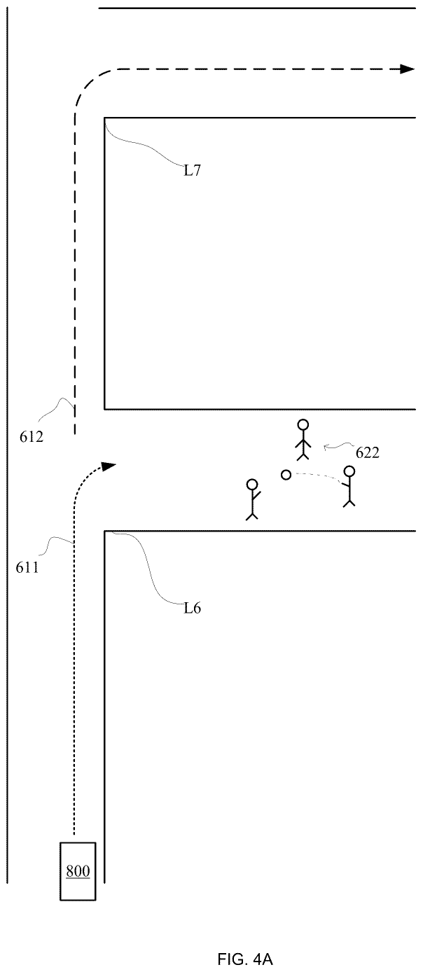

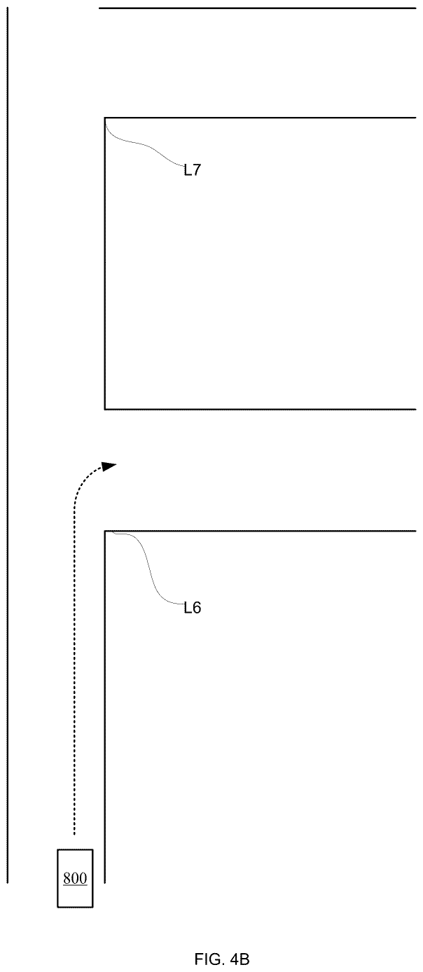

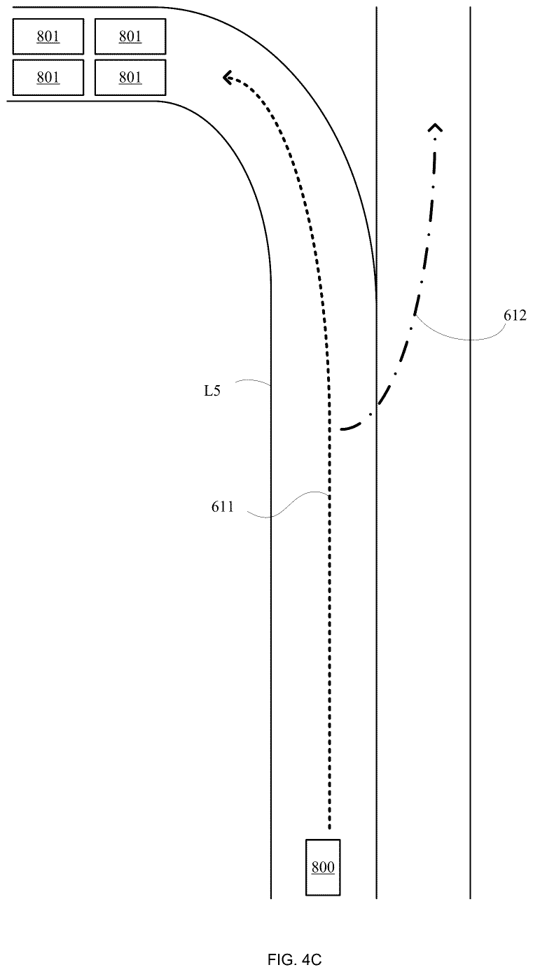

FIG. 4A illustrates a vehicle that drives from location L5 and is expected to turn right at location L6 by following path segment 601. When approaching L6, the vehicle sees that children 622 are playing ball and virtually prevent the vehicle from turning to the right (the children may be seen using additional environmental information—see step 541 of FIG. 1C)—and the vehicle may select a new set of artificial intelligence models that provide a decision to skip the turning at L6—to proceed straight forward and turn at location 74—see path segment 612.

FIG. 4B illustrates a vehicle that drives from location L5 and is expected to turn right at location L6 by following path segment 601. When approaching L6, the vehicle sees that it can turn at L6—as the road following L6 to the right is empty—and the vehicle 800 follows its original path.

FIG. 4C illustrates a vehicle that reaches location L5 and is expected to exit a highway. When approaching to the highway exit the vehicle senses that there is a traffic jam (see stuck vehicles 801) and may decide to follow the defined path 611 or to return to the highway (alternative path 612).

Because some aspects of the illustrated embodiments of the present disclosure may, for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any combination of any steps of any method illustrated in the specification and/or drawings may be provided. Any combination of any subject matter of any of claims may be provided. Any combinations of systems, units, components, processors, sensors, illustrated in the specification and/or drawings may be provided. Any combination of any module or unit listed in any of the figures, any part of the specification and/or any claims may be provided.

Any reference in the specification to a method should be applied mutatis mutandis to a device or system capable of executing the method and/or to a non-transitory computer readable medium that stores instructions for executing the method. Any reference in the specification to a system or device should be applied mutatis mutandis to a method that may be executed by the system, and/or may be applied mutatis mutandis to non-transitory computer readable medium that stores instructions executable by the system.

Any reference in the specification to a non-transitory computer readable medium should be applied mutatis mutandis to a device or system capable of executing instructions stored in the non-transitory computer readable medium and/or may be applied mutatis mutandis to a method for executing the instructions.

In the foregoing specification, the invention has been described with reference to specific examples of embodiments of the invention. It will, however, be evident that various modifications and changes may be made therein without departing from the broader spirit and scope of the invention as set forth in the appended claims. The specifications and drawings are, accordingly, to be regarded in an illustrative rather than in a restrictive sense.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Those skilled in the art will recognize that boundaries between the above-described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub-combination.

It will be appreciated by persons skilled in the art that the embodiments of the disclosure are not limited by what has been particularly shown and described hereinabove. Thus, the scope of the embodiments of the disclosure is defined by the appended claims and equivalents thereof. While certain features of the disclosure have been illustrated and described herein, many modifications, substitutions, changes, and equivalents will now occur to those of ordinary skill in the art. It is therefore to be understood that the appended claims are intended to cover all such modifications and changes as fall within the true spirit of the invention.

What is claimed is:

1. A method for real time predictive driving maneuver assist for autonomous driving applications, comprising:
identifying a location of an expected driving maneuver in a driving path of a vehicle, wherein the expected driving maneuver is associated with a scenario in the driving path of the vehicle;
collecting statistical data pertaining to artificial intelligence models activated, in a driving of vehicles, in accordance with the scenario;
obtaining environmental information regarding an environment of the driving of the vehicle; and
determining, in real-time and before the vehicle reaching the location of the expected driving maneuver, by processing the collected statistical data with the environmental information in accordance with the scenario, a set of artificial intelligence models to provide a decision making for assisting with the expected driving maneuver when the vehicle reaches the location of the expected driving maneuver.

2. The method according to claim 1, wherein the processing involves identifying a scenario signature, generated in association with the scenario, that matches the environmental information associated with the scenario.

3. The method according to claim 1, further comprising:
obtaining additional environmental information before a completion of the expected driving maneuver; and
selecting a selected artificial intelligence model of the determined set of artificial intelligence models further based on the additional environmental information.

4. The method according to claim 1, further comprising activating at least one artificial intelligence model of the determined set when reaching the location of the expected driving man.

5. The method according to claim 1, further comprising:
obtaining additional environmental information regarding the location of the expected driving maneuver; and
verifying that the determined set of artificial intelligence models are relevant to the location of the expected driving maneuver.

6. A non-transitory computer readable medium storing instructions that, when executable by at least one processing device, cause the processing device to:
identify a location of an expected driving maneuver in a driving path of a vehicle, wherein the expected driving maneuver is associated with a scenario in the driving path of the vehicle;
collect statistical data pertaining to artificial intelligence models activated, in a driving of vehicles, in accordance with the scenario;
obtain environmental information regarding an environment of the driving of the vehicle; and
determine, in real-time and before the vehicle reaching the location of the expected driving maneuver, by processing the collected statistical data with the environmental information in accordance with the scenario, a set of artificial intelligence models to provide a decision making for assisting with the expected driving maneuver when the vehicle reaches the location of the expected driving maneuver.

7. The non-transitory computer readable medium according to claim 6, further causing the processing device to identify a scenario signature, generated in association with the scenario, that matches the environmental information associated with the scenario.

8. The non-transitory computer readable medium according to claim 6, further causing the processing device to:
obtain additional environmental information before a completion of the expected driving maneuver; and
select a selected artificial intelligence model of the determined set of artificial intelligence models further based on the additional environmental information.

9. The non-transitory computer readable medium according to claim 6, further causing the processing device to activate at least one artificial intelligence model of the determined set when reaching the location of the expected driving man.

10. The non-transitory computer readable medium according to claim 6, further causing the processing device to:
obtain additional environmental information regarding the location of the expected driving maneuver; and
verify that the determined set of artificial intelligence models are relevant to the location of the expected driving maneuver.

11. A system of real time predictive driving maneuver assist for autonomous driving applications, the system comprising at least one processing device configured to:
identify a location of an expected driving maneuver in a driving path of a vehicle, wherein the expected driving maneuver is associated with a scenario in the driving path of the vehicle;
collect statistical data pertaining to artificial intelligence models activated, in a driving of vehicles, in accordance with the scenario;
obtain environmental information regarding an environment of the driving of the vehicle; and
determine, in real-time and before the vehicle reaching the location of the expected driving maneuver, by processing the collected statistical data with the environmental information in accordance with the scenario, a set of artificial intelligence models to provide a decision making for assisting with the expected driving maneuver when the vehicle reaches the location of the expected driving maneuver.

12. The system according to claim 11, wherein the processing the collected statistical data with the environmental information involves identifying a scenario signature, generated in association with the scenario, that matches the environmental information associated with the scenario.

13. The system according to claim 12, wherein the processing device is further configured to generate the scenario signature in association with the scenario.

14. The system according to claim 11, wherein the processing device is further configured to:
obtain additional environmental information before a completion of the expected driving maneuver; and
select a selected artificial intelligence model of the determined set of artificial intelligence models further based on the additional environmental information.

15. The system according to claim 1, wherein the processing device is further configured to activate at least one artificial intelligence model of the determined set when reaching the location of the expected driving man.

16. The system according to claim 11, wherein the processing device is further configured to:
obtaining additional environmental information regarding the location of the expected driving maneuver; and
verify that the determined set of artificial intelligence models are relevant to the location of the expected driving maneuver.
